(19) United States
(12) Patent Application Publication
(10) Pub. No.: US 2025/0391071 A1
(43) Pub. Date: Dec. 25, 2025

(54) METHOD FOR RESOLVING GEOMETRIC CONSTRAINTS OF A SKETCH

(71) Applicant: TOPSOLID, Evry (FR)

(72) Inventor: Christian ARBER, Paris (FR)

(21) Appl. No.: 18/748,235

(22) Filed: Jun. 20, 2024

(51) Int. Cl. G06T 11/60; G06T 11/20

(52) U.S. Cl. CPC G06T 11/60; G06T 11/203; G06T 2200/24

(57) ABSTRACT

A method for solving geometric constraints of a sketch, wherein the following steps are implemented: a computer interaction device displays to a user an initial sketch respecting one or more initial geometric constraints; via the computer interaction device, the user sets new geometric constraints by modifying at least one of the initial geometric constraints; a computer calculation device determines, using transformations of the Möbius group, a transformed sketch respecting the new geometric constraints; and the computer interaction device displays the transformed sketch to the user.

### FIELD OF THE INVENTION

The invention relates to the resolution of geometric constraints of a sketch.

### BACKGROUND OF THE INVENTION

Computer-aided design (CAD) software allows a user to create and modify a virtual object, which can subsequently be manufactured from plans produced by the software. To design the object virtually, the software allows the user to create geometric elements (points, portions of straight lines, circles, spheres, etc.), to manipulate them and to associate them with each other so as to draw, on a computer screen, a wireframe sketch, in two or three dimensions. The sketch generally defines the contours of the future object, its shapes, its dimensions.

Thus, the geometric elements of the sketch are associated with parameters specific to each element, such as coordinates, values of length, radius, or curvature. In addition, some geometric elements are defined only using other geometric elements. For example, a point can be defined as the intersection of straight lines on the sketch. The user can also constrain the elements already created with respect to each other, creating new parameters constraining the geometry of the sketch. The aim is in particular to define values of distance or angles between two elements, parameters of parallelism, passage of an element through a particular point, etc. The user expects the CAD software to display a sketch respecting the manipulations and constraints that s/he commands. In this respect, the software brick responsible for determining and displaying a sketch that respects all the parameters is generally called a GCS for Geometric Constraint Solver or System since it must always provide a sketch satisfying a set of geometric constraints set by the user.

To achieve this task, in the 1990s, geometric constraint solvers used in particular “parametric” methods, in which the geometric constraints were considered to form a tree with several levels, each geometric constraint depending on other constraints set beforehand. The solver therefore satisfactorily solved the constraints as the sketch was created, but any modification of a parameter could be difficult depending on the order in which the sketch had been constrained. Thus, if a modification of the sketch involved modifying a constraint set beforehand, the user themselves had to modify, or even delete and reproduce, the geometric elements of the sketch produced after creating this constraint. In other words, the user was responsible for producing the construction tree of the figure, i.e. its resolution scheme, according to an ordered and chronological construction method. Complex sketches were therefore difficult to modify satisfactorily.

In more recent state-of-the-art software, the order in which the sketch was produced and constrained no longer matters. The user can choose to freeze some of these parameters, and to allow some of them to change freely, independently of how s/he built the sketch. The frozen values then form geometric constraints that the sketch must respect regardless of the modifications made to the free parameters. Thus, when the user modifies a free element of the sketch, for example when s/he moves a point or a segment of the sketch, the role of the software is to continuously display the sketch respecting not only this new constraint but also all the other geometric constraints set elsewhere. Consequently, whenever the sketch is modified, the software must find a solution to a geometric constraint system, regardless of how and the order in which they were produced, to display a sketch respecting all the constraints defined by the user.

Methods are known to solve this type of geometric problem, for example as described in document “Handbook of geometric constraint systems principles” by Meera Sitharam, Audrey St John and Jessica Sidman. The solver generally acts by producing a virtual graph in which the nodes of the graph correspond to the geometric elements of the sketch, the edges corresponding to the geometric constraints. This graph is then reduced, using methods derived from the graph theory, into an assembly of irreducible components.

Then, the irreducible components are generally solved by a numerical method, which is either global (Buchberger algorithm for example), or local by estimating a solution using a gradient flow or other known methods.

However, these numerical methods, for solving irreducible components, may be too slow to provide a solution to the problem of geometric constraints set by the user. Thus, these methods do not always guarantee a suitable response time for the user when s/he makes a modification to their sketch, thereby penalising the user's experience: the correct sketch is not displayed quickly on the screen, or even no solution is found and the desired sketch cannot be displayed.

Document “La mécanique des Sphères de Lie: un futur pour la CAO?” (The mechanics of Lie Spheres: a future for CAD?”) by Christian Arber and Frédéric Jean, describes a method for solving irreducible components that is an alternative to the known methods and which operates differently. It consists in considering each geometric element of the sketch as a sphere in the space of Lie spheres. By doing so, instead of considering a point, a line, a circle, a sphere of the sketch, or a portion of one of these elements differently, each of these geometric elements is considered as a vector with four components (for a two-dimensional sketch) or with five components (for a three-dimensional sketch), the only difference between them being the values of these components. This space of Lie spheres, also called Space of Spheres in the literature, is a vector space provided with a quadratic form that can be used to measure a quantity between two spheres. All the usual constraints can be formulated using this quantity or formulae based on this quantity. The formalism thus identical for each element of a sketch makes the geometric constraint system easier to solve.

However, one disadvantage of all the known methods for solving these geometric constraint systems is the inability to send or pass points of the sketch to infinity when the user manipulates the sketch. When the user modifies the parameters of elements of a sketch in fact, the solution calculated by the solver, to solve a series of geometric constraints, sometimes consists in transforming a finite value of one of the geometric elements into an infinite value. This is the case, for example, when a point is defined by the intersection of two straight lines, and the user makes these straight lines parallel, the point then being sent to infinity. In addition sometimes, this infinite value must be transformed back into a finite value depending on the user's manipulations, the value then having passed through infinity during a continuous manipulation. This is the case, for example, if the user make the straight lines, which had become parallel, intersecting again. This type of transmission or passage through infinity may also concern the centre of a circle when the circle is transformed into a straight line, in other words when its curvature becomes zero or its radius infinite. Similarly, if a circular arc is inverted, then its curvature changes sign on passing through zero, and the centre of the circle passes through infinity before returning to the finite space. These positions where a point passes through infinity are qualified as singular at infinity and generally correspond to a situation where the algorithm performs a division by zero.

For all these cases, and in particular in the case of a continuous type resolution (i.e. when dragging a geometry from one position to another, crossing the singularity) the sketch becomes blocked on the screen, either when sending the points to infinity or when bringing them back, as the solver cannot find a solution to the new system of equations to be solved for points passing through infinity. The user experience is therefore penalised.

### SUMMARY

The invention aims in particular to display to the user a sketch satisfying the geometric constraints set, within an acceptable response time, when the user's manipulations take parameters of the sketch, at least temporarily, to infinite values.

The invention therefore relates to a method for solving geometric constraints of a sketch, in which the following steps are implemented:
computer interaction means display to a user an initial sketch respecting one or more initial geometric constraints;
via computer interaction means, the user sets new geometric constraints by modifying at least one of the initial geometric constraints;
computer calculation means determine, using transformations of the Möbius group, a transformed sketch respecting the new geometric constraints;
the computer interaction means display the transformed sketch to the user.

Thus, the transformations of the Möbius group are in some respects the unknowns to be solved to make the system converge from an initial position to a solved position.

The term “Möbius group” designates the “circular group”, “conformal group”, or “symmetry group of conformal transformations of the Riemann sphere”. In addition, it is isomorphic to the Lorentz group called SO(3,1) for the transformations in a plane, SO(4,1) in a three-dimensional space, such that the transformations of the Möbius group also correspond to the transformations of the Lorentz group.

However, while the transformations of the state of the art consist of simple transformations, such as similarities, elements of a subgroup of the Möbius group, the Möbius group includes other transformations allowing the line to change to the circular arc and vice versa, in other words the processing of points passing through infinity. We therefore look for unknown transformations in a larger group, which allows displacements from infinity, and therefore allows an infinite point of the sketch to change to a usual point, or a zero curvature of the sketch to change to a non-zero curvature.

In other words, the solver may find a transformed sketch that respects the new geometric constraints even if this involves sending some elements of the sketch to infinity. The transformed sketch is displayed without blocking. Similarly, new manipulations by the user can bring points from infinity back to finite positions without difficulty, so that during the transformation, some elements have passed through infinity without causing the sketch to block on the screen. The user experience is therefore improved.

Advantageously, to determine the transformed sketch, the computer calculation means apply a transformation of the Möbius group to an initial geometric element of the initial sketch so as to transform it into a transformed geometric element of the transformed sketch.

Thus, a suitable transformation of the Möbius group is applied to a given geometric element so that all the initial elements are transformed into transformed elements which satisfy the new geometric constraints.

Preferably, the computer calculation means transform an initial value, associated with the initial geometric element, into a transformed value, associated with the transformed geometric element, the initial and transformed values corresponding to one of the following situations:
the initial value is a finite value, the transformed value is an infinite value;
the initial value is an infinite value, the transformed value is a finite value;
the initial value is a non-zero and positive value, the transformed value is a zero or negative value;
the initial value is a zero or respectively negative value, the transformed value is a non-zero or respectively zero or positive value.

Thus, using the transformations of the Möbius group, it is possible to determine a transformed sketch respecting the geometric constraints and in which a transformed element takes a value which would have blocked the sketch in the state of the art, such as an infinite value instead of a finite value, a negative curvature value instead of a positive curvature value, a zero value instead of a non-zero value.

Advantageously, the initial and transformed values are radius or curvature values.

Thus, it is now possible to invert a circle or a circular arc, so that its radius changes from a positive value to a negative value, its curvature changes sign on passing through zero, and the centre of the circle or the circular arc passes through infinity when the element has the shape of a straight line, during its inversion.

Preferably, to determine the transformed sketch, the following steps are implemented:
the computer calculation means determine, from the or each initial geometric element of the initial sketch, one or more respective initial spheres of the space of Lie spheres in order to represent the initial element in this space of Lie spheres;
the computer calculation means determine a system of equations to be solved, using the new constraints set, resulting from formulae based on the quadratic form of the space of the Lie spheres and relating to the or each of the initial spheres;
the computer calculation means determine, for the or each initial sphere, one or more suitable respective transformations of the Möbius group in order to transform the initial sphere into a transformed sphere so that the or all the transformed spheres determined are solutions of the system of equations;
the computer calculation means determine, from the or each transformed sphere, the respective transformed geometric element or elements, of the transformed sketch.

The use of Lie spheres is relevant insofar as an infinite affine space has been “compactified” into a spherical space, with no calculation singularity at infinity. The transformations associated naturally with this space are those of the Möbius group and are solved in order to move infinity if necessary.

Use of the space of Lie spheres and of Riemannian geometry, in other words the application of the transformations of the Möbius group to spheres, can therefore be used to solve problems of constrained geometries within a reasonable time for the user and by means of a solution whose points go to infinity if necessary.

Advantageously, to determine the suitable transformation or transformations of the Möbius group to be applied to the initial sphere or spheres, the computer calculation means perform a gradient flow for a function minimising a quadratic difference between a value of the new constraints set, depending on common Möbius transformations applied to the geometries, and a desired value.

Thus, the search for these transformations amounts to calculating a gradient flow on a product differential variety, Lie group, provided with a product metric applied by the frame system chosen for each sphere.

The invention also relates to a method for the computer-aided design of an object, wherein the following steps are implemented:
a sketch is produced, displayed by computer interaction means, by implementing the steps of the method described previously;
the sketch is transformed into a virtual object by associating with the sketch, using a constructive method and computer interaction means, surfaces, volumes and physical parameters, such as a material, a texture or a weight.

Thus, the sketch can be used to build basic surfaces and volumes by different generative methods (extrusion, revolution, pipe, etc.) which, combined together by topological operations, can be used to generate parts and objects that can be assembled, machined, etc.

Since the sketch can be modified more easily using the solving method of the invention, in particular when points of this sketch pass through infinity, a virtual object can be designed more easily and quickly, without the sketch being blocked on the screen or preventing a modification. It is therefore easier to design an object.

The invention also relates to a method for the computer-aided manufacture of an object, wherein the following steps are implemented:
a virtual object is designed using the method described previously;
an object corresponding to the real object is manufactured.

Thus, the object is manufactured all the more easily since it was designed easily using the design method of the invention.

The invention also relates to a method for setting geometric constraints by gestural interaction, wherein the following steps are implemented:
computer interaction means display to a user an initial sketch comprising at least one initial geometric element to which at least one initial finite value is associated;
via computer interaction means, the user performs a virtual movement so that a virtual point travels a distance d for a time t;
if the distance d is greater than a predetermined threshold and if the time t is less than a predetermined threshold, then computer calculation means transform the initial finite value into an infinite transformed value;
the computer calculation means determine, using transformations of the Möbius group, a transformed sketch comprising a transformed element, resulting from the initial element, to which the infinite transformed value is associated;
the computer interaction means display the transformed sketch to the user.

Thus, a user can deliberately send points to infinity by making a rapid drag movement materialised by the distance d and the time t. These points at infinity can be processed using the Möbius transformations applied to the initial sketch.

Preferably, the initial element and the transformed element correspond to one of the following situations:
the initial element is a point, the transformed element corresponds to the point sent to an infinite distance;
the initial element is a circle or a circular arc with a non-zero and positive curvature, the transformed element corresponds to the circular arc with a zero or negative curvature.

The invention also relates to a computer program, comprising instructions which, when the program is executed by a computer, instruct the computer to implement any one of the methods described previously.

The invention also relates to a computer-readable data medium, on which the previous computer program is stored.

Lastly, the invention also relates to a data processing device comprising means for implementing any one of the methods described previously.

### BRIEF DESCRIPTION OF THE FIGURES

The invention will be better understood on reading the following description, given solely by way of example and with reference to the accompanying drawings in which:

FIG. 1 is a diagram of a system according to the invention;

FIG. 2 is a flowchart of a method according to a first embodiment of the invention;

FIG. 3 is a flowchart of a method according to a second embodiment of the invention;

FIG. 4 is a view of a first initial wireframe sketch;

FIG. 5 is a view of a transformed sketch resulting from the initial sketch of FIG. 4;

FIG. 6 is a view of another transformed sketch resulting from the initial sketch of FIG. 4;

FIG. 7 is a view of a second initial wireframe sketch;

FIG. 8 is a view of a transformed sketch resulting from the initial sketch of FIG. 7.

### DETAILED DESCRIPTION

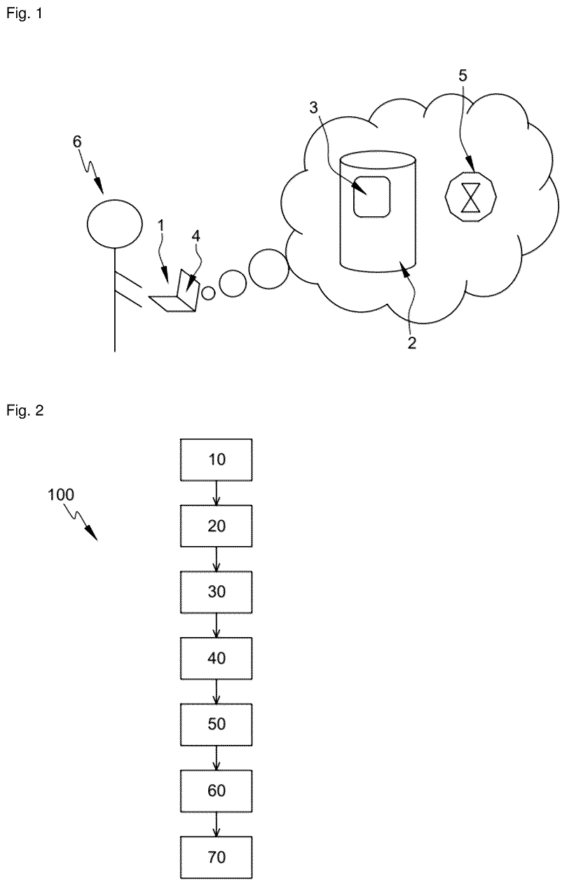

The invention is implemented by computer. Thus, as shown on FIG. 1, a computer 1 contains a data medium 2, which comprises in stored form a computer program 3 which, when it is executed on the computer 1, can be used to implement the steps of the methods which will be described below. In particular, the software associated with this program 3 is computer-aided design (CAD) software and, in this program 3, the software brick 7 called a “geometric constraint solver” is used to solve geometric problems and display sketches transformed by the user even in specific cases such as the passage of points through infinity, as will be explained below. The computer 1 is equipped with computer interaction means 4, such as a screen, a keyboard, a mouse. It is also equipped with the other usual systems available on conventional computers, in particular computer calculation means 5, such as a processor, to execute the program 2. To control the computer 1 and therefore execution of the program 3, a user 6 manipulates the computer using the means 4. The invention also relates to any data processing device, instead of a computer, adapted to implement the steps which will be described below.

In the remainder of the document, we will describe the steps of a method 100 schematised on FIG. 2, referring to the sketches of FIGS. 4 to 6, implementing the invention via the environment of FIG. 1.

The user 6 creates and modifies, using the program 3, a wireframe sketch displayed on the screen of the means 4. This sketch moves in a two- or three-dimensional space.

Thus, in step 10 of this method 100, the user produces the sketch 11 of FIG. 4. It is considered to be the initial sketch, in other words the sketch as it is before the subsequent transformations. We explain below how it is created. The user 6 produces geometric elements, such as circular arcs, straight lines, points. S/he associates values with them. For example, a radius of curvature of value “12” is associated with the circular arc 13. However, the user 6 leaves this parameter free, so that if after modifying another element of the sketch this value must change, it will then do so freely to satisfy all the geometric parameters of the sketch. Similarly, the circular arc 15, defined by association with other elements, is not constrained, its curvature remaining free to change. However, s/he associates a value of “100” with the segment 12, and a value of “10” with the perpendicular segment 14. In these cases, s/he sets these values, in other words s/he constrains the sketch 11 to respect the values of the segments 12 and 14 regardless of the future transformations of the sketch 11.

Consequently, starting from this initial sketch 11, the modifications made by the user will cause the free parameters, such as the circular arcs 13 and 15, to change naturally so that the sketch displayed on the screen continues to respect the geometric constraints, such as the values of the segments 12 and 14. Thus, whenever the user requests a change, the geometric constraint solver 7 of the software must find a sketch which satisfies all the new constraints set. In particular, when moving a geometric element, the solver must always find a sketch which respects all the constraints.

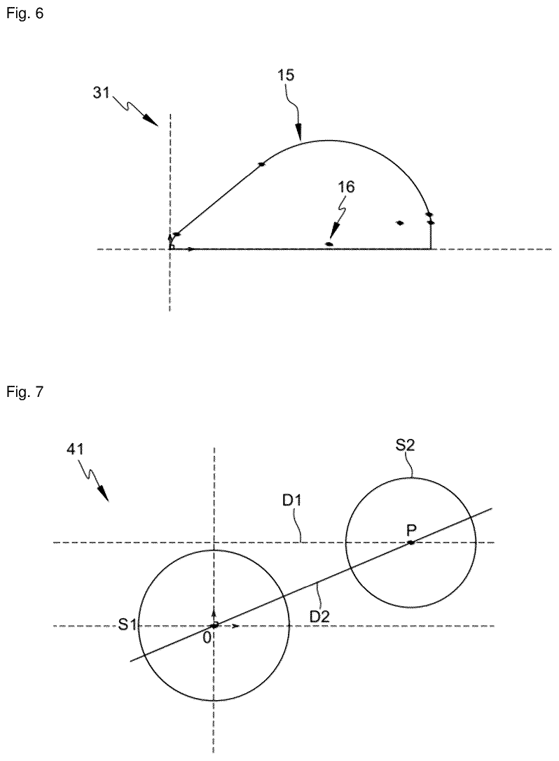

An example of a transformed sketch, starting from the initial sketch 11, is that of the sketch 21 on FIG. 5, in which the user has moved the circular arc 15 towards the bottom of the sketch, therefore modifying its curvature and its radius, as well as the other elements of the sketch that are free to move. The segments 12 and 14 have remained frozen. This manipulation also shows the centre 16 of the circular arc 15. This point 16 is a construction element of the sketch, moving automatically with the element to which it is associated by construction, in this case the circular arc 15.

Another example of a transformed sketch is that of the sketch 31 of FIG. 6. This time, the circular arc 15 has been inverted, not only with respect to the sketch 21 of FIG. 5, but also with respect to the initial sketch 11 of FIG. 4. However, by inverting the circular arc 15, its curvature has changed sign. In addition, if the user has inverted the circular arc not instantaneously (by a change of value), but continuously, through a movement, then, during the inversion, the centre 16 has been moved, and has necessarily passed through infinity, since at one stage of this continuous inversion, the circular arc 15 was necessarily a straight line. These configurations are blocking in the state of the art, since a solver of the state of the art is unable to manage this passage through infinity and this inversion of curvature mathematically in a continuous solving method. It is in particular to manage this type of case that the solver 7 of the invention implements the steps 20 to 70 of the method 100 of FIG. 2. We will now see how the solver can be used to move from the initial sketch 11 of FIG. 4 to the transformed sketch 31 of FIG. 6.

In step 20, the solver 7 associates a sphere of the space of Lie spheres with each geometric element of the initial sketch 11. In concrete terms, regardless of whether the element is a point, a line segment, a circular arc, or a spherical portion, the solver 7 assigns it a vector with four components (five components if the sketch was drawn in a three-dimensional space).

The general equation of a generalised sphere in the space of Lie spheres is as follows:

$$q : k ( {x}^{2} + {y}^{2} ) + nx x + ny y = h \qquad [ Math 1 ]$$

Each 4-uple (nx, ny, h, k) (a 5-uple in three dimensions) designates a geometric element of the sketch and at the same time a unique sphere of the space of Lie spheres to within one multiplying factor. According to this equation, if k=0, the associated geometric element is a straight line. The element of the form q=1 is defined as a point sent to infinity. In addition, quadratic and polar forms are associated with each of these elements. Thus, the quadratic form is defined by:

$$B ( q , q ) = ( {‖ n ‖}^{2} + 2 kh ) \qquad [ Math 2 ]$$

where q is a sphere of the space of Lie spheres.
The associated polar form is defined by:

$$B ( q , {q}^{′} ) = ( n \vert {n}^{′} ) + ( {kh}^{′} + {hk}^{′} ) \qquad [ Math 3 ]$$

where q and q′ are two spheres of the space of Lie spheres, with respectively the components (nx, ny, k, h) and (nx′, ny′, k′, h′). We may note for example that B(p,p)=0 if p is a point, and that B(d,d)=1 and B(d, infinity)=0 if d is a straight line of normed vector n.

In step 30, the solver 7 determines a system of equations to be solved to display a sketch respecting the given constraints. Thus, these polar and quadratic forms are used to work with the constraints set by the user to the elements of the sketch in the form of equations to be solved. All the geometric parameters of the sketch elements, in fact, such as the values of radius, curvature and distance, as well as the values of parallelism, angle between two elements, or passage of the elements through a point, can be defined using polar and quadratic forms of the space of Lie spheres. For example, if q is a parallel straight line at a distance d from the straight line D passing through a point O, then the associated equations are as follows: B(q,∞)=k=0, B(q, D)=1, B (q, O)=−d, where O is normalised so that B(O, Infinity)=−1, and B(q,q)=1. An angle constraint is for example, between two normed elements q and s, defined by B (q, s)=cos(angle) and B (q,q)=1.

Thus, all the geometric constraints of a sketch are defined by a set of equations of the following form:

$$B ( Si , Sj ) = C ( i , j ) \qquad [ Math 4 ]$$

where i and j are geometric elements of the sketch, Si and Sj the generalised spheres associated with these elements, and C is the corresponding constraint value. These constraints are called elementary constraints.

These equations may also take a more general form as follows, such as a linear or even a polynomial form of quantities B(Si, Sj):

$$\sum Cij \cdot B ( Si , Sj ) = C \qquad [ Math 5 ]$$

Thus, concerning the initial sketch 11, one or more equations are associated with each constraint of the sketch. When the user manipulates the sketch by attempting to change a degree of freedom of one or more geometries, only the degrees of freedom that are free of any constraint may change, the role of the solver 7 being to determine a transformed sketch which satisfies all the new constraints imposed that must be respected by the geometries.

To help solve this problem, in step 40, the solver 7 transforms this geometric problem into a positioning problem, by determining, for each sphere of the sketch, an orthonormal frame, within the meaning of the underlying quadratic space (space of spheres), placed on the sphere. The solver 7 then tries to solve, for each sphere, the orthogonal transformation (i.e. belonging to the Möbius group), which, applied to the frame associated with the sphere, will move this frame, and therefore the sphere, so that the constraints are satisfied more and more closely.

In step 50, the solver 7 determines a mathematical variety associated with the possible displacements of the spheres. Starting from the problem of positioning the frames (F1, F2, . . . , Fp) associated with the Lie spheres of the geometric elements of the initial sketch 11, the solver 7 must find the transformation element g=(g1, g2, . . . , gp) which satisfies the geometric constraints given by the manipulations of the user 6, in order to solve the system of the following equations, for each elementary constraint Cₖ:

$$B ( {g}_{i} \cdot {s}_{{i}_{k}} {,}_{{F}_{i}} , {g}_{j} \cdot {s}_{{j}_{k ,}} {,}_{{F}_{j}} ) = {C}_{k} \qquad [ Math 7 ]$$

This variety is a product variety of Möbius groups, each group containing one of the unknown transformations gᵢ. Since the Möbius group is a Lie group, the product variety is itself a Lie group. However, where the state of the art only uses certain simple transformations, in particular similarities, the geometric transformations considered by the solver 7 consist of all the transformations of the Möbius group, also called “conformal group” or “circular group”.

In step 60, the solver 7 performs a gradient flow on this variety. The starting space is the product space of the various transformations which will be applied to the spheres representing the geometry. It is a Lie group, and an element of this group will be written g. The equations are linearised to apply a gradient flow method. Since the variables to be solved are transformations of the Möbius group, the linearised variables are the members of the vector space, Lie algebra of this group, and these variables will be referred to as Dg in the remainder of this document.

The function f subject of the gradient flow is the quadratic sum of the differences, D_{ck}, between the current values of the constraints and the desired values:

$${\sum }_{k = 1}^{k = M} {Dck}^{2} \qquad [ Math 8 ]$$

where M is the number of geometric constraints. This gradient flow is performed by integrating the equation:

Dg=−grad(f(g))·dt. In order to calculate the gradient, the metric applied to the tangent space (Lie algebra) must be known. This is the Riemannian metric associated with the infinitesimal transformations induced by the frames. After solving Dg by inverting the metric, we then calculate its exponential to obtain g, and therefore all the displacements of the Möbius group to be applied to each sphere in order to approach order 1 of the desired constraints and tend to cancel the function f. These displacements are also limited to remain within the linearity domain of the method. Thus, on each iteration, the solver tries to move towards the solution that best minimises the function f, according to a gradient flow on a Lie group expressed as follows:

$$f ( g ) = {\sum }_{k = 1}^{k = M} {( Ck ( g ) - Ck )}^{2} \qquad [ Math 9 ]$$

where g is the vector of transformations (g1, g2, . . . , gp) applied to the elements of the sketch, Ck representing the constraints.

In step 70, the solver 7 identifies the appropriate vector g, and therefore all the transformations resulting from the Möbius group which apply to each geometric element of the initial sketch 11 to satisfy the modifications requested by the user 6. The program 3 then displays the transformed sketch on the screen to the user 6.

Thus, if the user has entered one or more values generating the instantaneous “transmission” of elements of the initial sketch to infinity, the corresponding transformed sketch is displayed without blocking. Similarly, if the transformation made by the user is continuous, by dragging elements of the geometry, and while dragging sends points through infinity and/or inverts elements, the program can display all the intermediate sketches without blocking as dragging progresses. In the case of the sketch 31, as we have seen, the centre 16 passes through infinity, in particular if the modification was continuous. The transformations of the Möbius group made this possible since infinity is considered as a point, where the other conventional transformations, such as the similarities, would have made any calculation impossible. It is therefore the transformations resulting from the Möbius group which allow the sketch 11 to progressively, on the initiative of the user 6, become the sketch 31, without the passage of the point 16 through infinity being blocking. Obviously, the transformation could also be instantaneous, for example if the user suddenly supplies a curvature value of different sign.

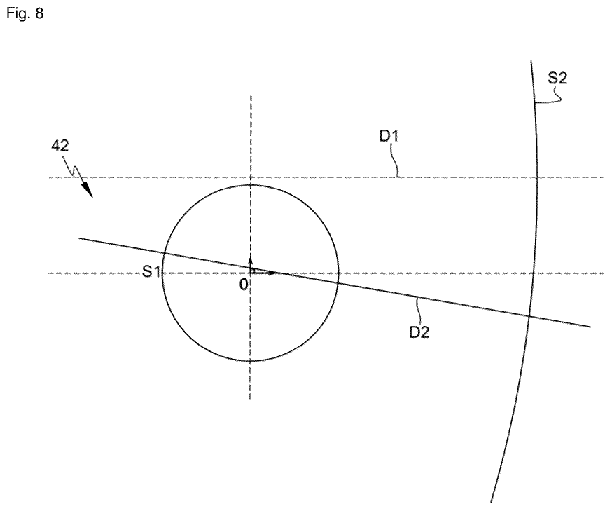

Another example is that of FIGS. 7 and 8.

On FIG. 7, the initial sketch 41 represents two circles S1 and S2 and a straight line D2 joining the two centres of the circles S1, S2. The circle S1 is fixed, it cannot be modified by the user. On the contrary, the circle S2 can be enlarged and moved horizontally by its centre P. P can in fact only be moved along a fixed horizontal straight line D1. Lastly, D2 can be turned around the centre of S1 by the user. Thus, when the user turns D2, P, the centre of S2, is moved in translation along D1. When D2 becomes parallel to the X axis, P is rejected to infinity. Since P is the centre of S2, the fact that it is sent to infinity means that the circle S2 then degenerates into a straight line.

FIG. 8 shows what happens in intermediate positions. Thus, in a transformed sketch 42 resulting from the initial sketch 41, the point P, too far away, is no longer visible, and we observe that the radius of the circle S2 has increased considerably. This is due to the fact that when the point P is projected to infinity, the radius of S2 becomes infinite, and this circle degenerates even into a vertical straight line. In an intermediate position such as that of the sketch 42, the radius is therefore very large, it adapts to the position of P.

We therefore see that the transformations of the Möbius group allow in this case a continuous variation of the radius of a circle, passing in particular through an infinite value, and that a point, P in this case, can be projected to infinity and return without blocking the screen.

More generally, the solver 7 can be used, by processing the transmission of points to infinity, to determine transformed sketches, in particular in the following situations:
when a circular arc or a circle becomes a straight line, its curvature becomes zero, its radius becomes infinite and its centre is projected to infinity;
when a circular arc or a circle is inverted, for example when the previous movement continues, its curvature and its radius change polarity and its centre passes through infinity before taking up a given position;
when the point of intersection of two straight lines is sent to infinity by transforming the straight lines into parallel lines.

The method 100 of FIG. 2 also simplifies the design of virtual objects. By simplifying the production of a sketch by processing points passing through infinity, in fact, the solver 7 makes it easier for the user 6 to model objects. The software brick 7 can therefore be integrated into computer-aided design software in order to design objects more easily and more quickly.

In addition, by making an object easier to design, it can be manufactured more quickly. It is therefore worthwhile introducing into the process of designing and manufacturing an object, the software brick 7 that can be used, during its design, to define the object more quickly. Similarly, the solver 7 could be integrated into computer-aided manufacturing (CAM) software, the manufacture being faster for the same reasons.

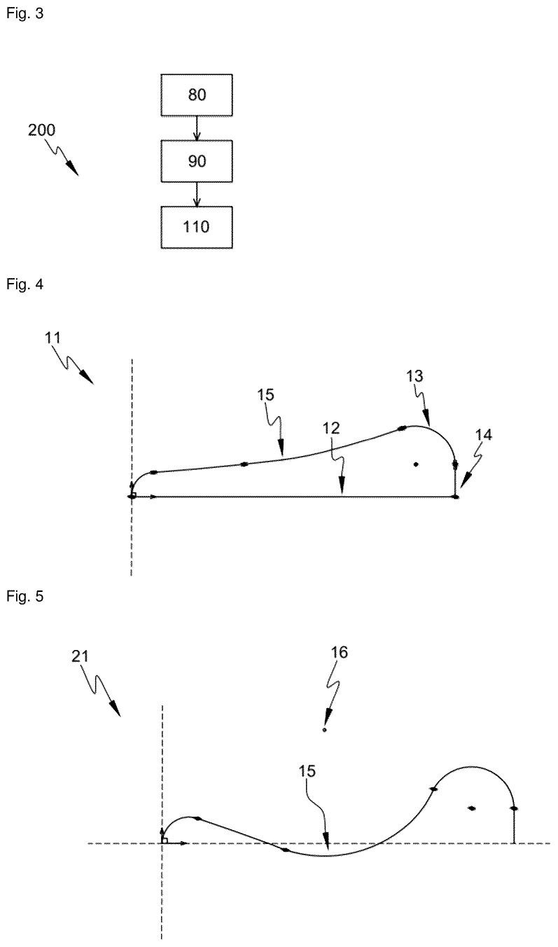

Referenced on FIG. 3, a second embodiment of the invention can be used to allow the user to deliberately send points of the sketch to infinity, by making an intuitive gesture. Thus, in step 80 of this method 200, the user 6 has an initial sketch, with at least one point at a determined position, that s/he can select. In step 90, s/he makes this point travel, for a predetermined time, for example less than half a second, a determined distance, for example greater than a given portion of the screen. By this manipulation, the user commands the program 3 to send this point to infinity, in other words to assign it a value of infinite positioning or infinite distance from an origin. In step 110, the solver 7 solves the geometric constraints, in particular those which involve sending the point to infinity, so as to display the transformed sketch on the screen. The resolution is identical to that of the method 100 described previously. This manipulation is therefore made relevant due to the ability of the solver 7 to precisely process the case of points passing through infinity, provided that it can display a sketch thus transformed without any calculation difficulties. Thus, by making a sudden intuitive gesture, the user “throws” points to infinity and therefore instinctively modifies their sketch. This type of gesture can indirectly transform the sketch in a different way. For example, if the point sent to infinity is the centre of construction of a circle or of a circular arc of the sketch, then this circle or circular arc is transformed into a straight line when the centre is sent to infinity.

An opposite gesture, making a point “return” from infinity, can also be processed in the same way by the invention.

The invention is not limited to the embodiments described and other embodiments will be clearly apparent to those skilled in the art.

1. A method for solving geometric constraints of a sketch, characterised in that the following steps are implemented:
computer interaction means display to a user an initial sketch respecting one or more initial geometric constraints;
via computer interaction means, the user-sets new geometric constraints by modifying at least one of the initial geometric constraints;
computer calculation means determine, using transformations of the Möbius group, a transformed sketch respecting the new geometric constraints;
the computer interaction means display the transformed sketch to the user.

2. The method according to claim 1, wherein, to determine the transformed sketch, the computer calculation means apply a transformation of the Möbius group to an initial geometric element of the initial sketch so as to transform it into a transformed geometric element of the transformed sketch.

3. The method according to claim 2, wherein the computer calculation means-transform an initial value, associated with the initial geometric element, into a transformed value, associated with the transformed geometric element, the initial and transformed values corresponding to one of the following situations:
the initial value is a finite value, the transformed value is an infinite value;
the initial value is an infinite value, the transformed value is a finite value;
the initial value is a non-zero and positive value, the transformed value is a zero or negative value;
the initial value is a zero or respectively negative value, the transformed value is a non-zero or respectively zero or positive value.

4. The method according to claim 3, wherein the initial and transformed values are radius or curvature values.

5. The method according to claim 2, wherein, to determine the transformed sketch, the following steps are implemented:
the computer calculation means determine, from the or each initial geometric element of the initial sketch, one or more respective initial spheres of the space of Lie spheres in order to represent the initial element in this space of Lie spheres;
the computer calculation means determine a system of equations to be solved, using the new constraints set, resulting from formulae based on the quadratic form of the space of the Lie spheres and relating to the or each of the initial spheres;
the computer calculation means determine, for the or each initial sphere, one or more suitable respective transformations of the Möbius group in order to transform the initial sphere into a transformed sphere so that the or all the transformed spheres determined are solutions of the system of equations;
the computer calculation means determine, from the or each transformed sphere, the respective transformed geometric element or elements, of the transformed sketch.

6. The method according to claim 5, wherein, to determine the suitable transformation or transformations of the Möbius group to be applied to the initial sphere or spheres, the computer calculation means perform a gradient flow for a function minimising a quadratic difference between a value of the new constraints set, depending on common Möbius transformations applied to the geometries, and a desired value.

7. A method for the computer-aided design of an object, characterised in that the following steps are implemented:
a sketch is produced, displayed by computer interaction means, by implementing the steps of the method according to claim 1;
the sketch is transformed into a virtual object by associating with the sketch, using a constructive method and computer interaction means, surfaces, volumes and physical parameters, such as a material, a texture or a weight.

8. A method for the computer-aided manufacture of an object, wherein the following steps are implemented:
a virtual object is designed using the method according to claim 7;
an object corresponding to the real object is manufactured.

9. A method for setting geometric constraints by gestural interaction, characterised in that the following steps are implemented:
computer interaction means display to a user an initial sketch comprising at least one initial geometric element to which at least one initial finite value is associated;
via computer interaction means, the user performs a virtual movement so that a virtual point travels a distance d for a time t;
if the distance d is greater than a predetermined threshold and if the time t is less than a predetermined threshold, then computer calculation means transform the initial finite value into an infinite transformed value;
the computer calculation means determine, using transformations of the Möbius group, a transformed sketch comprising a transformed element, resulting from the initial element, to which the infinite transformed value is associated;
the computer interaction means display the transformed sketch to the user.

10. The method according to claim 9, wherein the initial element and the transformed element correspond to one of the following situations:
the initial element is a point, the transformed element corresponds to the point sent to an infinite distance;
the initial element is a circular arc with a non-zero and positive curvature, the transformed element corresponds to the circular arc with a zero or negative curvature.

11. A computer program, characterised in that it comprises instructions which, when the program is executed by a computer, instruct the computer to implement the method according to claim 1.

12. A computer-readable data medium, on which the computer program according to claim 11 is stored.

13. A data processing device characterised in that it comprises means for implementing the method according to claim 1.
